(19) United States
(12) Patent Application Publication
(10) Pub. No.: US 2020/0192442 A1
(43) Pub. Date: Jun. 18, 2020

(54) MANAGING AND DISTRIBUTING ANTENNA POWER BASED ON TEMPERATURE

(71) Applicant: MOTOROLA MOBILITY LLC, CHICAGO, IL (US)

(72) Inventors: MD RASHIDUL ISLAM, LOMBARD, IL (US); HUGH K. SMITH, PALATINE, IL (US); MARTIN R. PAIS, NORTH BARRINGTON, IL (US)

(21) Appl. No.: 16/219,789

(22) Filed: Dec. 13, 2018

(51) Int. Cl. G06F 1/20; H01Q 3/24; H04W 52/02; H04W 52/26; H04W 52/36

(52) U.S. Cl. CPC G06F 1/206; H01Q 3/247; H04W 52/367; H04W 52/267; H04W 52/0209

(57) ABSTRACT

A communication device, method, and computer program product monito, by a controller, respective temperatures of two or more antennas of the communication device. A first antenna of the two or more antennas has a first temperature. A modem of the communication device transmits data to the first antenna. The controller compares each of the respective temperatures to a corresponding temperature threshold. In response to determining that the first temperature exceeds the temperature threshold, the controller determines whether at least one second antenna of the two or more antennas has an associated second temperature that is less than a corresponding second temperature threshold. In response to determining that at least one second antenna has a second temperature that is less than the corresponding second temperature threshold, the controller selects a second antenna from among the at least one second antenna and switches data transmission to the selected second antenna.

### BACKGROUND

### 1. Technical Field

The present disclosure relates generally to communication devices with multiple antennas, and more particularly to managing multiple antennas of a communication device.

### 2. Description of the Related Art

Cellular communications has expanded into multiple communication band and modulation schemes through the evolution of the telecommunications standard from first generation (1G), second generation (2G), third (3G), fourth generation (4G), and soon fifth generation (5G). Wireless wide area network (WWAN) that supports cellular communication typically requires relatively high uplink transmit power to reach a radio access network (RAN), which can be kilometers away. With the evolution of the technology in each generation, the data rates have increased dramatically. In 5G, with multiple input multiple output (MIMO) and integrated 4G, the data rate is predicted to support upwards of 6.24 giga-bits per second (Gbps). As data rates increase, noise increases, heat dissipation increases, and temperature of the communication device rises.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 is a simplified functional block diagram illustrating a communication device having multiple antennas, according to one or more embodiments;

FIG. 2 is a flow diagram illustrating a method for managing and distributing antenna power to manage thermal dissipation in a communication device, according to one or more embodiments;

FIG. 3 is a diagram of communication device that has one antenna shadowed by a user and that is experiencing a heat load scenario, according to one or more embodiments;

FIG. 4 is a flow diagram illustrating a method for rotating antennas selected for transmitting, based on both temperature and shadowing, according to one or more embodiments;

FIG. 5 is a diagram of a navigation scenario of communication device moving with a vehicle along a navigation route, according to one or more embodiments; and

FIG. 6 is a flow diagram illustrating a method of managing heat loads on multiple antennas of a communication device by opportunistically adjusting data transmit rates based on predicted thermal loads, according to one or more embodiments.

### DETAILED DESCRIPTION

According to aspects of the present innovation, a communication device, a method, and a computer program product provide management and distribution of antenna power based on temperature. A controller of the communication device monitors respective temperatures of two or more antennas of the communication device. A first antenna of the two or more antennas has a first temperature. A modem of the communication device transmits data to the first antenna. The controller compares each of the respective temperatures to a corresponding temperature threshold. In response to determining that the first temperature exceeds its corresponding temperature threshold, the controller determines whether at least one second antenna of the two or more antennas has an associated second temperature that is less than a corresponding second temperature threshold. In response to determining that at least one second antenna has a second temperature that is less than the corresponding second temperature threshold, the controller selects a second antenna from among the at least one second antenna. The controller switches data transmission from the modem to the selected second antenna.

In one aspect of the present disclosure, a communication device has two or more antennas that are spatially separated. The communication device includes two or more temperature sensors positioned to sense a temperature of respective ones of the two or more antennas. The communication device includes at least one modem communicatively coupled to the two or more antennas. The communication device includes a controller that is communicatively coupled to the modem. The communication device executes an antenna selection utility that enables the communication device to monitor, by the controller, respective temperatures of two or more antennas of the communication device, including a first antenna having a first temperature. The modem transmits data to the first selected antenna. The controller compares each of the respective temperatures to a corresponding temperature threshold. In response to determining that the first temperature exceeds its corresponding temperature threshold, the controller determines whether at least one second antenna has an associated second temperature that is less than a corresponding second temperature threshold. In response to determining that at least one second antenna has a second temperature that is less than the corresponding second temperature threshold, the controller selects a second antenna from among the at least one second antenna. The controller switches data transmission from the modem to the selected second antenna.

According to one or more aspects of the present disclosure, a computer program product includes program code on the computer readable storage device that when executed by a processor associated with a communication device, the program code enables the communication device to provide the functionality of monitoring, by a controller, respective temperatures of two or more antennas of the communication device, including a first antenna having a first temperature. The functionality includes transmitting data by a modem to the first antenna and comparing each of the respective temperatures to its corresponding temperature threshold. In response to determining that the first temperature exceeds the temperature threshold, the controller determines whether at least one second antenna of the two or more antennas has an associated second temperature that is less than a corresponding second temperature threshold. In response to determining that at least one second antenna has a second temperature that is less than the corresponding second temperature threshold, the controller selects a second antenna from among the at least one second antenna. The controller switches data transmission from the modem to the selected second antenna.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, similar elements are provided similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention.

The description of the illustrative embodiments can be read in conjunction with the accompanying figures. Embodiments incorporating teachings of the present disclosure are shown and described with respect to the figures presented herein.

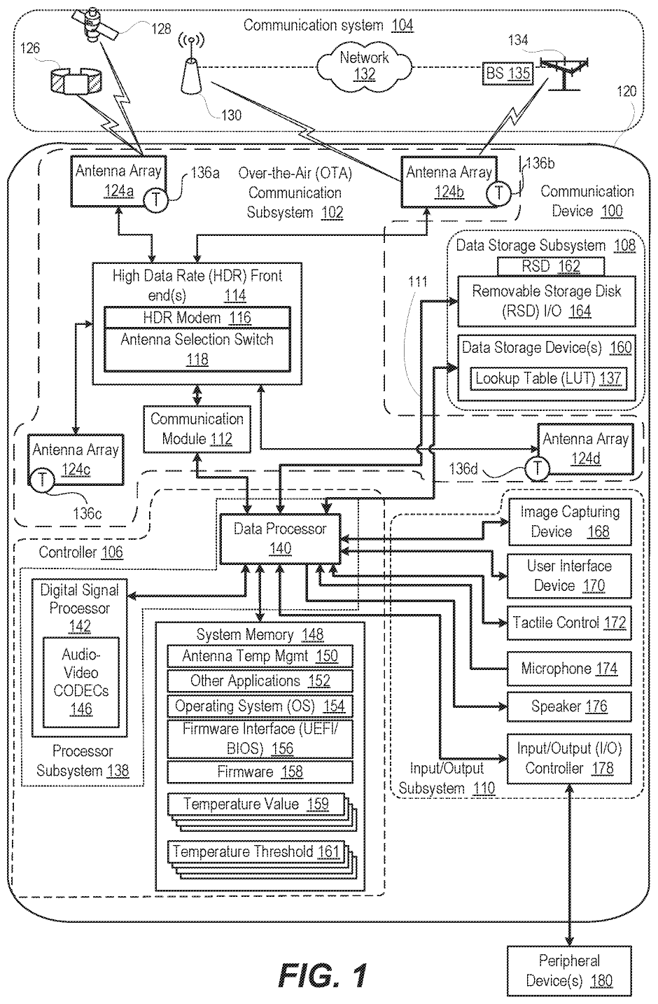

FIG. 1 is a simplified functional block diagram illustrating communication device 100 that manages and distributes antenna power based at least in part on temperature. In one or more embodiments, communication device 100 incorporates wireless communication capabilities to operate as a wireless user device. Communication device 100 can be one of a host of different types of devices, including but not limited to, a mobile cellular phone or smart-phone, a laptop, a net-book, an ultra-book, a networked smart watch or networked sports/exercise watch, and/or a tablet computing device or similar device that can include wireless communication functionality. As a device supporting wireless communication, communication device 100 can be one of, and also be referred to as, a system, device, subscriber unit, subscriber station, mobile station (MS), mobile, mobile device, remote station, remote terminal, user terminal, terminal, user agent, user device, cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. These various devices all provide and/or include the necessary hardware and software to support the various wireless or wired communication functions as part of a communication system. Communication device 100 can also be an over-the-air link in communication system that can be intended to be portable or hand-held or for which a user can move into close proximity. Examples of such communication device 100 include a wireless modem, an access point, a repeater, a wirelessly-enabled kiosk or appliance, a femtocell, a small coverage area node, and a wireless sensor, etc.

Referring now to the specific component makeup and the associated functionality of the presented components, communication device 100 includes over-the-air (OTA) communication subsystem 102 that communicates with an external communication system 104. Communication device 100 provides computing and data storage functionality in support of this OTA communication, as well as other functions with controller 106, data storage subsystem 108, and input/output (I/O) subsystem 110 that are communicatively coupled via a system interlink 111.

OTA communication subsystem 102 includes communication module 112 that encodes data for transmission and decodes received data according to an applicable communication protocol. OTA communication subsystem 102 includes high data rate (HDR) front end(s) 114 having HDR modem 116. HDR modem 116 modulates baseband encoded data from communication module 112 onto a carrier signal to provide a transmit signal. HDR front end(s) 114 has an antenna selection switch 118 for communicatively coupling HDR modem 116 to selected antennas that are spatially separated within device housing 120. In one or more embodiments, the antennas are depicted as four antenna arrays 124a-d, positioned respectively at a top left, top right, midpoint left lateral side, and midpoint right lateral side of device housing 120. Antenna arrays 124a-d transmit the transmit signals and also receive received signals. HDR modem 116 demodulates the received signal from antenna arrays 124a-d, separating received encoded data from a received carrier signal.

For clarity, only one HDR modem 116 is included. However, two or more modems can be included that are under control of controller 106. For example, one modem can provide data simultaneously to two antennas that operate for spatial diversity in a multiple input multiple output (MIMO) configuration. Another modem can be assigned to other antennas. For another example, each antenna, when selected, can be serviced by a dedicated modem. Switching selection of antennas can be achieved by controller 116 directing data to a different modem.

Controller 106 controls the communication, user interface, and other functions and/or operations of communication device 100. These functions and/or operations thus include, but are not limited to including, application data processing and signal processing. Wireless communication device 100 may use hardware component equivalents such as special purpose hardware, dedicated processors, general purpose computers, microprocessor-based computers, micro-controllers, optical computers, analog computers, dedicated processors and/or dedicated hard wired logic. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. Although certain direct interconnections are illustrated in FIG. 1, it is to be understood that more, fewer, or different interconnections may be present in other embodiments.

In one or more embodiments, controller 106 via OTA communication subsystem 102 can perform multiple types of OTA communication with the external communication system 104. OTA communication subsystem 102 can communicate with one or more of a personal access network (PAN) device such as smartwatch 126 via a Bluetooth wireless link, global positioning system (GPS) satellite 128, and node 130 of a wireless local access network (WLAN). WLAN node 130 is in turn connected to a wide area network 132, such as the Internet. OTA communication subsystem 102 can also communicate with radio access network (RAN) 134 having a base station (BS) 135. RAN 134 is a part of a wide area access network (WWAN) that is connected to network 132 and provides data or voice services. Base station 134 generally requires uplink transmit power levels that are much higher than the low power PAN and WLAN.

As used herein, “node” generally refers to OTA communication equipment that enables communication device 100 to wirelessly connect to a communication network. Communication device transmits and/or receives one or more of data, audiovisual content, voice communication, software, etc., via the node. In one or more embodiments, the nodes are geographically spaced as RANs that enable connection using WWAN protocols. Thermal load on communication device 100 caused by communicating with a particular node can be a function of at least one or both of: (i) transmit power level; and (ii) data rate of transmission. Thermal load can also be affected by data rate of reception and amount of processing required to demodulate and decode received data.

Antenna arrays 124a-d are expected to heat rapidly to support newer technologies such as fifth generation (5G) data rates. The localized heat load on a system on a chip (SoC) that supports MIMO antenna configurations, especially in the millimeter wave frequency bands can be very high. With antennas located on a periphery of a communication device, a user can experience discomfort if thermal management of such surfaces is not maintained. At the high data rate, such thermal loads can quickly increase the surface temperature of the communication device. Abnormally hot temperatures can also affect performance and reliability of the communication device. A shutdown can be necessary when a high temperature is detected. Conventional methods of thermal management require heat spreaders or heat sinks to channel localized heat sources to a greater area of the communication device. These heat spreaders and heat sinks take up space, add weight, and in some instances reduce energy efficiency.

To directly or indirectly measure a respective temperature of each antenna array 124a-d, communication device 100 includes corresponding temperature sensors “T” 136a-d, which are positioned integral with, in proximity to, or adjacent to corresponding antenna arrays 124a-d. Sensed temperature may be a directly measured value or be determined by extrapolating a temperature value based on one or more sensors in proximity to a particular antenna arrays 124a-d. Sensed temperature increases are primarily related to use of a particular antenna array 124a-d to transmit according to transmit power level and communication data rate provided by

HDR front end(s) 114. According to aspects of the present disclosure, controller 106 monitors temperature via temperature sensors 136a-d and directs HDR front end(s) 114 to avoid overheating antenna arrays 124a-d. In one or more embodiments, controller 106 also monitors activities being performed, or scheduled to be performed, by communication device 100. Based on the monitored activities and sensed temperatures, controller 106 can access a lookup table (LUT) 137 to determine a predicted time-temperature behavior of communication device 100, or a portion of communication device 100. LUT 137 can enable a prediction of a temperature for a particular antenna array 124a-d.

Controller 106 includes processor subsystem 138 that executes program code to provide functionality of the communication device 100. Processor subsystem 138 includes one or more central processing units (CPUs) (“data processor”) 140. Processing subsystem 138 can include a digital signal processor (DSP) 142. DSP 142 can have hardware or software that is directed to operating as audio or video compression-decompression modules (CODECs) 146. Controller 106 includes system memory 148 for containing actively used program code and data. System memory 148 can include therein a plurality of such program code and modules, including application such as antenna temperature management application 150 and other applications 152. System memory 148 can also include operating system (OS) 154, firmware interface 156 such as basic input/output system (BIOS) or Uniform Extensible Firmware Interface (UEFI), and platform firmware (FW) 158. These software and/or firmware modules have varying functionality when their corresponding program code is executed by processor subsystem 138 or secondary processing devices within communication device 100. Data, such as current temperature values data structure 159 for each temperature sensors 136a-d and corresponding temperature thresholds data structure 161, is stored in system memory 148.

Data storage subsystem 108 provides nonvolatile storage accessible to controller 106. For example data storage subsystem 108 can provide a large selection of other applications 152 that can be loaded into system memory 148. Local data storage 160 can include hard disk drives (HDDs), optical disk drives, solid state drives (SSDs), etc. In one or more embodiments, removable storage device (RSD) 162 that is received in RSD interface 164 is a computer readable storage device, which can be referred to as non-transitory. RSD 162 can be accessed by controller 106 to provision communication device 100 with program code that when executed by controller 106 provides the functionality to communication device 100 to perform aspects of the present disclosure.

I/O subsystem 110 provides input and output devices, such as for presenting or receiving content that is carried by OTA communication. For example, image capturing device 168, such as a camera, can receive gestures and other image data. User interface device 170 can present visual or tactile outputs as well as receive user inputs. Tactile/haptic control 172 can provide an interface such as for braille reading or manual inputs. Microphone 174 receives user audible inputs. Audio speaker 176 can provide audio output including audio playback and alerts. I/O subsystem 110 can be wholly or substantially encompassed by device housing 120 or be connected via I/O controller 178 as peripheral device 180. I/O controller 178 can also interface with wired local access network (LAN).

In certain applications, such as gaming and handheld communication modes, I/O subsystem 110 is in direct contact with a user. Maintaining a comfortable surface temperature of communication device 100 increases user experience. To facilitate and support higher performance while maintaining comfortable surface temperature, controller 106 leverages the MIMO antenna architecture of antenna arrays 124a-d in such a way as to distribute the heat generated across each of antenna arrays 124a-d. Rotating use of antennas can include avoiding use of any antennas shadowed by proximity to where a user is touching communication device 100.

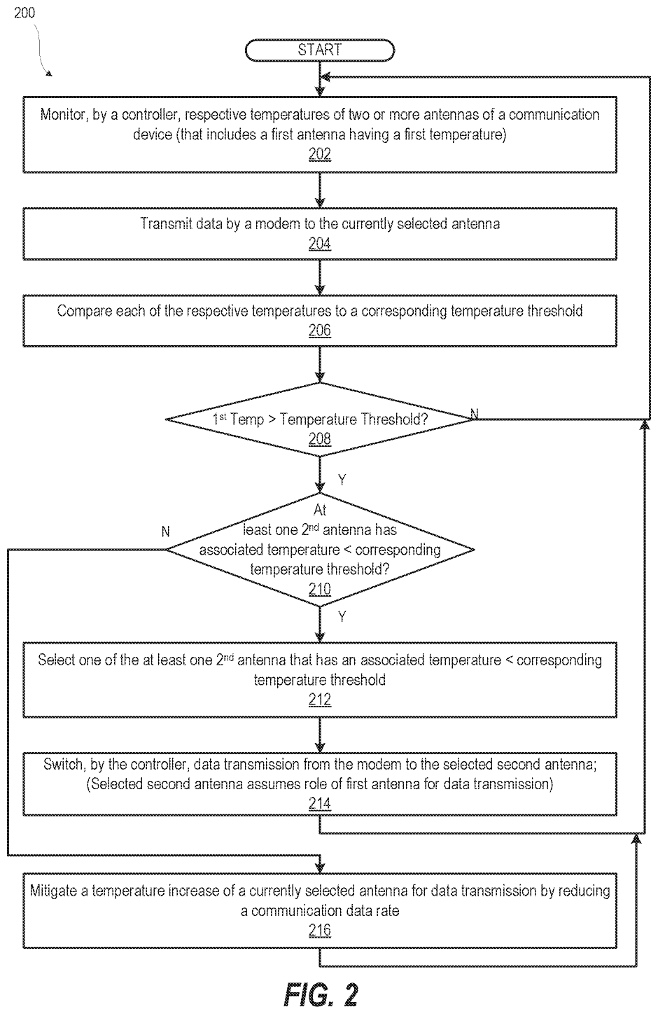

FIG. 2 is a flow diagram illustrating method 200 for managing and distributing antenna power in order to manage (or in response to) thermal dissipation in communication device 100 (FIG. 1). In one or more embodiments, method 200 includes monitoring, by controller 106 (FIG. 1), respective temperatures of two or more antennas of the communication device (block 202). The communication device includes a first antenna having a first temperature. Method 200 includes transmitting data by a modem to a currently selected antenna, which initially is the first antenna (block 204). Method 200 includes comparing each of the respective temperatures to a corresponding temperature threshold (block 206).

For clarity, each of the respective temperatures of the antennas can be compared against the same temperature threshold. In one or more embodiments, each antenna can have a corresponding temperature threshold that is different from at least one other antenna. For example, an antenna can have proximity to functional components that require a lower operating temperature. For another example, an antenna can have a physical difference from another antenna that tends to degrade in operation with temperature in a different manner. In one or more embodiments, the comparison can yield a binary determination of whether or not any particular antenna is overheated, enabling round robin switching of the next antenna that is not overheated. In one or more embodiments, the comparison can yield quantitative information about how far below a temperature threshold a particular antenna is, enabling selection of the relatively coolest antenna as the next active antenna.

A determination is made whether the first temperature exceeds the temperature threshold (decision block 208). In response to determining that the first temperature does not exceed the temperature threshold, method 200 returns to block 202. In response to determining that the first temperature exceeds the temperature threshold, method 200 includes determining whether at least one second antenna of the two or more antennas has an associated second temperature that is less than the corresponding second temperature threshold (decision block 210). In response to determining that at least one second antenna has an associated second temperature that is less than the corresponding second temperature threshold, method 200 includes selecting, by the controller, one of the at least one second antenna with an associated second temperature that is less than the corresponding second temperature threshold (block 212). Method 200 includes switching, by the controller, data transmission from the modem to the selected second antenna (block 214). Then method 200 returns to block 202. In response to determining that there was not at least one second antenna of the two or more antennas that has an associated second temperature that is less than the corresponding second temperature threshold, method 200 includes mitigating a temperature increase of a currently selected antenna for data transmission by reducing a communication data rate (block 216). Then method 200 returns to block 202.

In one or more embodiments, method 200 includes mitigating the temperature increase of the currently selected antenna by selecting the coolest second antenna or the second antenna with greatest temperature margin from the corresponding second temperature threshold. In one or more embodiments, method 200 includes mitigating the temperature increase of the currently selected antenna by discontinuing data transmission.

In one or more embodiments, controller 106 (FIG. 1) can throttle a rate of data transmission to manage the thermal load to mitigate the temperature increase of the currently selected antenna. Data rate reduction can include turning off modem 116 (FIG. 1) for a period of time in a pulse width modulation approach. Data rate reduction can include lowering a continuous data rate to a lower rate. In one or more embodiments, controller 106 can directly control data rate. In one or more embodiments, controller 106 can indirectly control data rate with direct control being handled by modem 116. The amount of throttling of data transmission can be proactively based on an estimate of heat loads as a function of time. In one or more embodiments, controller 106 dynamically reduces data rates to avoid temperatures rising above a temperature threshold and controller 106 implements opportunistic data rate increases to maintain performance over time, as heat loads allow. Mitigations can include reverting to a lower data rate, such as going from 5G to 4G or from 4G to 3G. In one or more embodiments, controller 106 can estimate thermal loads based on content that is queued for presentation on a user interface device. As generally a small, tightly integrated device, management of thermal energy created by transmission from the antennas is affected by other heat-generating functional components. Switching selection of antennas distributes thermal energy around the communication device. Mitigations that predict overall thermal load generated by the communication device identify opportunities and constraints that the antenna subsystem as a whole should operate within. Knowledge of the amount of power required and thermal efficiency of the user interface device can be used to estimate thermal loads within the entire device. Queued content can be analyzed for visual brightness at current display settings and for auditory loudness at current speaker settings. Estimated heat load would correspond then to how dark and quiet versus bright and loud an output of a particular time segment of the queued content is determined to be. Controller can also assess an amount of internal processing that is required to decode or encode data as part of receiving, presenting or transmitting the data. Certain types of content can be associated with a higher level of computational activity that can affect an estimate of thermal loads, such as processing by a digital signal processor or CODEC. Thus, data rates can be opportunistically scheduled to take advantage of a visually dark scenario in a video feed that corresponds to lower thermal loads on communication device 100 (FIG. 1). Generally, presenting dim and dark colors on a display requires less power, and thus generates less heat, than a bright and colorful image. In one embodiment, data transmission rates can be opportunistically scheduled to take advantage of predicted lower transmit power levels as communication device 100 draws closer to a RAN along a navigation route, requiring a lower transmit power level.

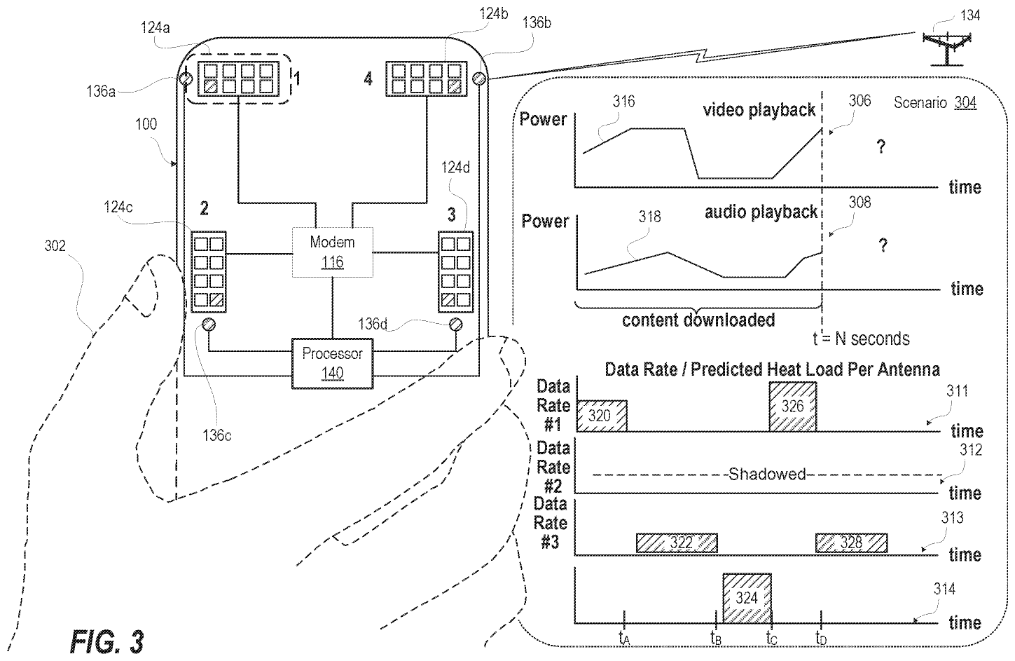

FIG. 3 is a diagram of communication device 100 that has one antenna 124c shadowed by user 302. Communication device 100 is operating in an illustrative scenario 304. Planned antenna switching is managed according to data for temperature based on predicted heat load. This data is illustrated in scenario 304 as estimated power plots 306, 308 respectively for video and audio playback. Estimated power is related to subsequent thermal loads that are managed by antenna switching. In addition to antenna switching for thermal management, communication device 100 benefits from mitigation by dynamically varying data rates as also illustrated by scenario 304. Scenario 304 includes data rate plots 311-314 as a function of time respectively for antenna #1-4 136a-d. Processor 140 has access to video and audio playback data 316, 318 respectively from estimated power plots 306, 308 that has been decoded and buffered prior to presentation on communication device 100. A common time line is illustrated for estimated power plots 306, 308 and data rate plots 311-314. Antenna switching occurs at times t_{A}, t_{B}, t_{C}, t_{D}, which are ordered from earliest to latest in time. From a current time t=0 until time t_{A}, heat load to present data 316, 318 is determined to go from a mid-level to a high level and remain high until time t_{B}. Heat load for presenting data 316, 318 remains low from time t_{B} to time t_{C}. From time t_{C} to time t_{D}, heat load for presenting data 316, 318 ramps up to high. The buffer of data currently holds decoded data from current time t=0 to time t=N seconds ahead. In managing modem 116, processor 140 predicts that a current mid-level data rate (block 320) of transceiving by first antenna 124a is supportable until time t_{A}. Second antenna 124b is not available for transceiving due to shadowing when first antenna 124a reaches a temperature threshold at time t_{A}. After switching to third antenna 124c, data rate (block 322) of modem 116 is reduced to a low level to reduce heat load during high heat load from playback. Assuming data is consumed for playback at a consistent rate, the amount of buffered data 316, 318 is dynamically changed according to a current data rate. The data rate can be greater than or less than the rate of consumption of buffered data. The amount of currently buffered data is related to the difference between the current time and time t=N seconds ahead of the current time. During time intervals with lower data rates, the time value of N seconds becomes smaller. Fewer seconds of buffer data is maintained. Thus, buffered data is drawn down to support the thermal mitigation. During time intervals with higher data rates, the time value of N seconds becomes larger. A larger number of seconds of buffered data is maintained. The quantity of buffered data is increased. At time t_{B}, processor 140 switches modem 116 to fourth antenna 124d during a period of low thermal load from playback of data 316, 318, thus data rate (block 324) is set to high to replenish buffering of data 316, 318. At time t_{C}, processor 140 switches modem 116 back to first antenna 124a which can transceive at a high rate (block 326). At time t_{D}, after switching to third antenna 124c, data rate (block 328) of modem 116 is reduced to a low level to reduce heat load.

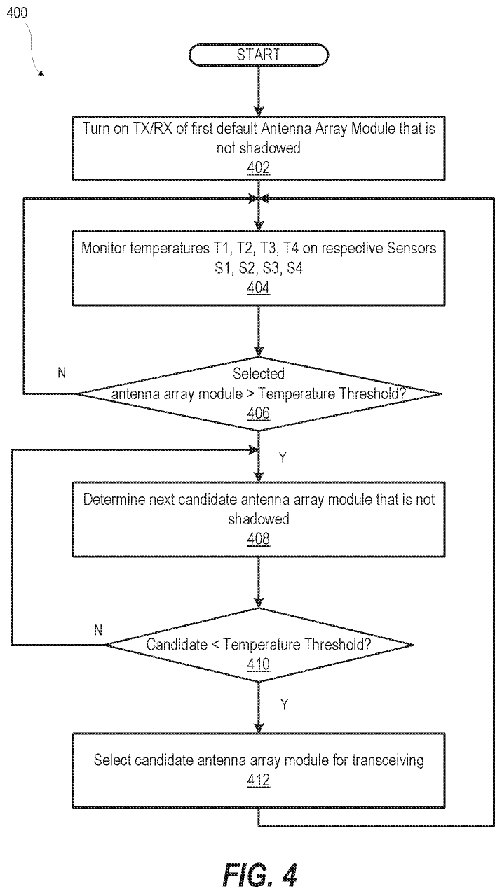

FIG. 4 is a flow diagram illustrating method 400 for rotating antenna selected for transmitting based on both temperature and shadowing. For clarity, method 400 is executed by controller 106 (FIG. 1) that rotates transmission between four antenna array modules, which can be the same as antenna arrays 124a-d (FIG. 1). Method 400 includes turning on transmit (TX) and receive (RX) operations of a first default antenna array module that is not shadowed (block 402). Method 400 includes monitoring temperature T1, T2, T3 and T4 on respective sensors S1, S2, S3 and S4 that correspond to antenna array modules (block 404). A determination is made whether the selected antenna array module has a temperature that is greater than a temperature threshold (decision block 406). In response to determining that the selected antenna array module has a temperature that is not greater than the temperature threshold, method 400 returns to block 404. In response to determining that the selected antenna array module has a temperature that is greater than the temperature threshold, method 400 includes determining a next candidate antenna array module that is not shadowed (block 408).

As presented herein, shadowing refers to interference with antenna performance based on a user touching or being close to an antenna. Fifth Generation (“5G”) mobile communications depend on millimeter-wave frequencies (e.g., >24 GHz). To realize an antenna gain sufficient to maintain a reliable communication link, for instance with a base station, electronic communication devices will likely need a much higher number of antenna elements positioned in various areas of the electronic communication device for diversity and multiple-input multiple-output (MIMO) applications. One concern with communications at millimeter-wave frequencies is that human tissues, such as skin, bone, muscle, and fat, are very lossy. For example, hand absorption can reduce peak gain of a millimeter-wave antenna array by 12 dB when the hand is around 5 millimeters from the antenna array. Accordingly, power savings can be realized if antenna arrays that are blocked by lossy objects are not used for high-power communications. Additionally, some regulatory entities specify power limitations on radio frequency (RF) transmissions.

Conventionally, various sensors such as capacitive, touch, and infrared (top hat) proximity sensors have been used for hand detection to avoid using antenna elements that are blocked or shadowed. However, due to the increase in antenna elements needed for communicating at millimeter-wave frequencies, the number of sensors needed for accurate hand detection may be impractical from control, management, power consumption, and cost perspectives. In such cases, determining object position can be based on determining mutual coupling values (“MCVs”) for pairs of the antenna arrays. An object's proximity to an antenna array generally affects one or more MCVs for one or more pair of antenna arrays. An object can be any object that interferes with transmissions. An MCV is a quantitative measure of signal strength, or more specifically, how much of a signal transmitted by a transmitting antenna element is received by a receiving antenna element. Accordingly, an MCV can indicate an efficiency of a signal transmitted, which is indicative whether or not an antenna is shadowed.

With continued reference to FIG. 4, a determination is made whether the next candidate antenna array has a temperature that is less than the temperature threshold (decision block 410). In response to determining that the next candidate antenna array does not have a temperature that is less than the temperature threshold, method 400 returns to block 408 to continue checking candidate antennas until one has a temperature less than the temperature threshold. In response to determining that the next candidate antenna array does have a temperature that is less than the temperature threshold, method 400 includes selecting the candidate antenna array for transceiving (block 412). Method 400 returns to block 404.

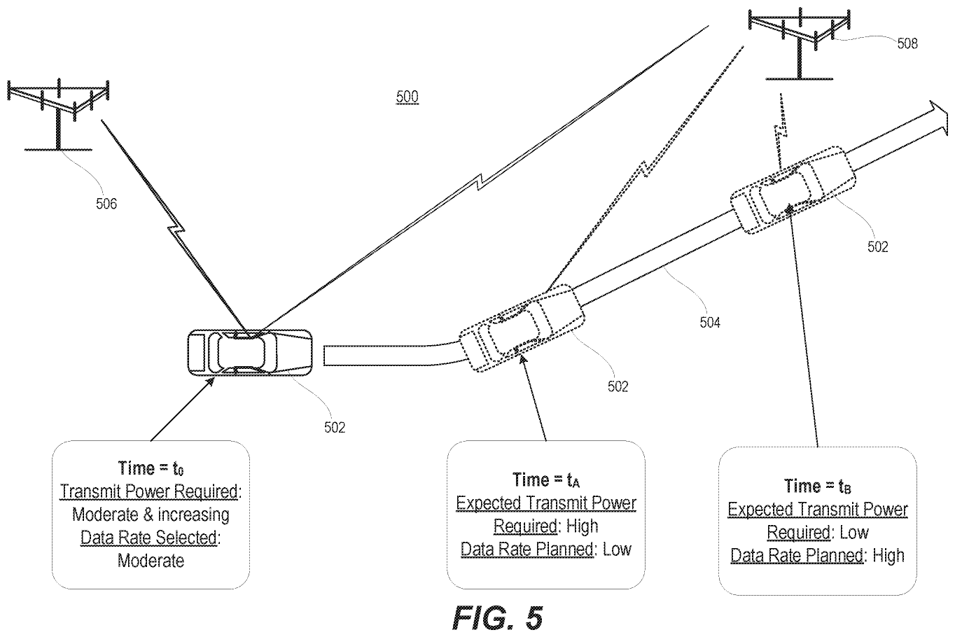

FIG. 5 is a diagram of navigation scenario 500 in which communication device 100 (FIG. 1) is moving within a vehicle 502 along a navigation route 504 that has cellular service provided by first RAN 506 and then a second RAN 508. At time to, communication device 100 (FIG. 1) in vehicle 502 scans for RANs and determines that RAN 506 is closer and requires a moderate level of transmit power. Vehicle 502 is predicted to move away from RAN 506 and toward RAN 508. Controller 106 (FIG. 1) can predict this moving away based on extrapolated current vector determined from transceiver direction/power measurements. Controller 106 (FIG. 1) can enhance this prediction based on tracking along the programmed navigation route 504 that is maintained by a navigational application of communication device 100 (FIG. 1). At time t_{A}, vehicle 502 is now closer to RAN 508 and controller 106 (FIG. 1) switches transceiving service to RAN 508. Because the expected transmit power level is high, the data rate planning for this portion of travel is set to low. The data rate planning establishes a ceiling on how much data can be transmitted within current thermal energy constraints. Actual data transmission rates can be less if demand by functional components of communication device 100 for data transmission is less than the ceiling. Also, low priority communications are deferred and buffered data is drawn down. At time t_{B}, vehicle 502 is now close to RAN 508 and low transmit power level is required. Data communication rate ceiling can be increased to high supporting an increase in communication data rate. Data intended for transmission is prioritized and queued when the currently allowed data rate ceiling is insufficient for prompt transmission.

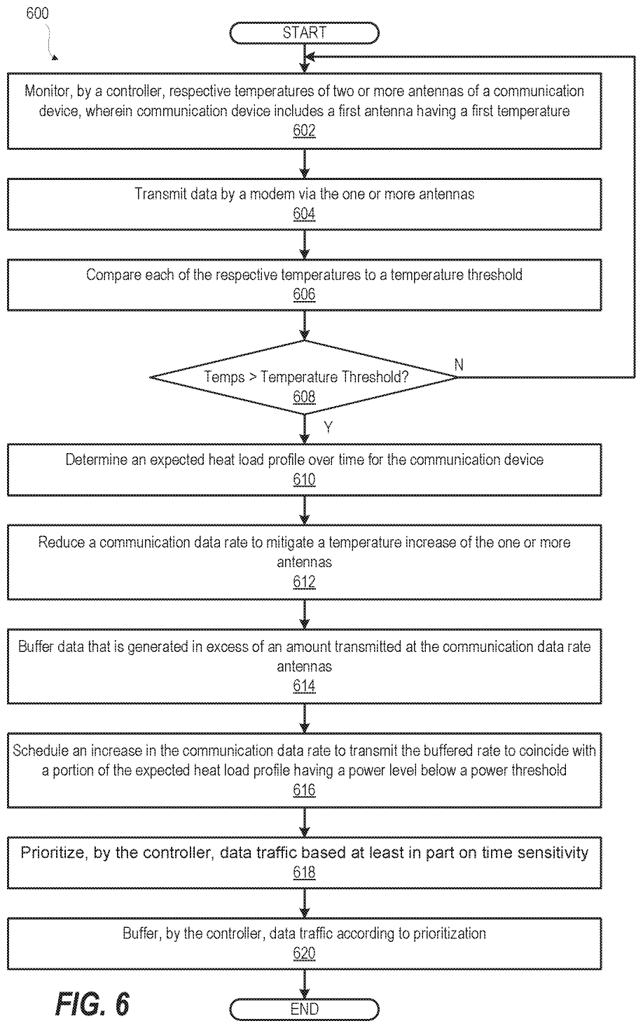

FIG. 6 is a flow diagram illustrating method 600 of managing heat loads on multiple antennas of a communication device by opportunistically adjusting data transmit rates based on predicted thermal loads. In one or more embodiments, method 600 includes monitoring, by a controller, respective temperatures of one or more antennas of a communication device (block 602). Method 600 includes transmitting data by a modem via the one or more antennas (block 604). Method 600 includes comparing each of the respective temperatures to a corresponding temperature threshold (block 606). A determination is made whether the respective temperatures exceed the corresponding temperature threshold (decision block 608). In response to determining that the respective temperatures does not exceed the temperature threshold, method 600 returns to block 602. In response to determining that the respective temperatures exceeds the temperature threshold, method 600 includes determining an expected heat load profile over time for the communication device (block 610). Heat loads can be estimated based on one or more factors associated with communication device 100 (FIG. 1). Examples of the factors include: (i) outside temperature; (ii) battery heating due to charging or discharging; (iii) computational processing by controller 106 (FIG. 1); (iv) amount of data transmitted; (v) transmit power level; (vi) power consumed in preventing audio, visual or haptic information; (vii) effect of ancillary equipment such as decorative or protective cover on rate of convective cooling of communication device 100 (FIG. 1); and (viii) rate of data reception. Controller 106 (FIG. 1) can access a lookup table that is provisioned with heat load values based on an operating state of communication device 100 (FIG. 1). Controller 106 (FIG. 1) can update the lookup table based on measured values that are correlated to a current operating state of communication device 100 (FIG. 1).

In one or more embodiments, in determining the portion of the expected heat load profile having the power level below the power threshold, method 600 includes (i) decoding media content to determine expected power consumption by a user interface of the communication device during playback of the media content; (ii) decreasing the communication data rate during a first portion of the playback of the decoded media content having expected power consumption above the power threshold; and (iii) increasing the communication data rate during a second portion of the playback of the decoded media content having expected power consumption below the power threshold.

Method 600 includes reducing a communication data rate for specific antennas with temperatures exceeding or approaching their respective/corresponding temperature threshold in order to mitigate a temperature load of the specific one or more antennas (block 612). The mitigation can include preventing a further increase. The mitigation can include lowering the temperature below the threshold. Method 600 includes buffering data that is generated in excess of an amount transmitted at the currently supported communication data rate (block 614). For example, controller 106 (FIG. 1) can select 4G communication protocol rather than 5G communication protocol to reduce data rate and thus heat load. Data generated in excess of the data rate supported by 4G communication protocol can be buffered until such time as either data generation slows or data rate of transmission increases. Method 600 includes scheduling an increase in the communication data rate to transmit the buffered rate to coincide with a time during which the expected heat load profile has a power level below a power threshold (block 616). A number of factors can affect what heat load can be supported by communication device 100. Given a current temperature for an antenna at a current operating state, ambient environment, and physical configuration of communication device 100 (FIG. 1), an estimate of thermal load can be made based on changes in power level of a particular subsystem of communication device 100. Method 600 includes prioritizing, by the controller, data traffic based at least in part on time sensitivity (block 618). For example, voice communication sessions can be preset as time sensitive and thus a higher priority in that user experience is degraded by breaks in spoken voice audio output. Main body of email or text messages, for example, can be preset as a medium priority. Large email or text attachments, by contrast, can be preset as a low priority, requiring user selection to either send or receive. Method 600 includes buffering, by the controller, data traffic according to prioritization (block 620). Thus, lower priority data traffic intended for transmission is deferred when a current data rate is insufficient for prompt transmission. Buffering of data traffic enables reduction in data rate for thermal management without loss of the data traffic. Then method 600 ends.

In a particular embodiment, method 600 includes determining the expected power consumption by the user interface by: (i) determining brightness and volume settings of one or more user interface devices of the communication devices; and (ii) determining a respective amount of power required to display video and present audio of the decoded media content based on the determined brightness and volume settings.

In one or more embodiments, method 600 includes determining the portion of the expected heat load profile having the power level below the power threshold by: (i) determining an expected navigation path of the communication device relative to one or more communication nodes; (ii) determining an expected dynamic transmission power level required for a communication session based on the expected navigation path and that contributes to the expected heat load profile; and (iii) scheduling increase in the communication data rate to coincide with an expected dynamic transmission power level that is less than the power threshold. In one or more embodiments, nodes are RANs 134 (FIG. 1) that support WWAN communication protocols.

In a particular embodiment, method 600 includes determining the expected navigation path by: (i) accessing an automatically-generated geographical route comprising a sequence of one or more road segments and expected road speeds along the sequence of one or more road segments; (ii) determining, via the two or more antennas, relative position of the one or more communication nodes to the geographical route; and (iii) determining the expected dynamic transmission power level as a function of time based on the expected position of the communication device and the relative distance to a closest one of the one or more nodes.

In one or more embodiments, method 600 includes determining the expected navigation path by: (i) determining a current position and velocity of the communication device; and (ii) extrapolating the current position based on the velocity. For example, controller 106 (FIG. 1) can determine a current vector of communication device 100. In one or more embodiments, method 600 determines the current vector based on at least one of: (i) n an internal inertial reference subsystem based on accelerometers of the communication device; (ii) triangulation measurements to fixed radio frequency (RF) sources such as RANs 134; or by communicating with GPS satellites 128 (FIG. 1). For example, controller can determine a current vector of communication device based on direction, strength, and phase delays detected in communicating with communication nodes.

In each of the above flow charts presented herein, certain steps of the methods can be combined, performed simultaneously or in a different order, or perhaps omitted, without deviating from the spirit and scope of the described innovation. While the method steps are described and illustrated in a particular sequence, use of a specific sequence of steps is not meant to imply any limitations on the innovation. Changes may be made with regards to the sequence of steps without departing from the spirit or scope of the present innovation. Use of a particular sequence is therefore, not to be taken in a limiting sense, and the scope of the present innovation is defined only by the appended claims.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

Aspects of the present innovation are described below with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiment was chosen and described in order to best explain the principles of the innovation and the practical application, and to enable others of ordinary skill in the art to understand the innovation for various embodiments with various modifications as are suited to the particular use contemplated.

What is claimed is:

1. A method comprising:
monitoring, by a controller, respective temperatures of two or more antennas of a communication device, including a first antenna having a first temperature;
transmitting data by a modem to the first antenna;
comparing each of the respective temperatures to a corresponding temperature threshold; and
in response to determining that the first temperature exceeds its corresponding temperature threshold:
determining whether at least one second antenna of the two or more antennas has an associated second temperature that is less than a corresponding second temperature threshold; and
in response to determining that at least one second antenna has a second temperature that is less than the corresponding second temperature threshold:
selecting, by the controller, a second antenna from among the at least one second antenna; and
switching, by the controller, data transmission from the modem to the selected second antenna.

2. The method of claim 1, further comprising:
in response to determining that no antenna from among the two or more antennas has a corresponding temperature that is less than the temperature threshold, mitigating a temperature increase of a currently selected antenna for data transmission by reducing a communication data rate.

3. The method of claim 2, further comprising:
determining, by the controller, whether any of the two or more antennas is shadowed by proximity body; and
in response to determining that a currently selected one of the first and second antennas either is shadowed or has a temperature that is greater than the temperature threshold:
identifying any candidate antennas of the two or more antennas that are not shadowed and has a temperature that is not greater than the temperature threshold;
in response to determining that at least one candidate antenna is identified:
selecting, by the controller, a third antenna from among the at least one candidate antenna; and
switching, by the controller, data transmission from the modem to the selected third antenna; and
in response to determining that no candidate antenna is identified, disabling transmission by the two or more antennas.

4. The method of claim 2, wherein reducing the communication data rate to mitigate a temperature increase of any currently selected antenna comprises:
decoding media content to determine expected power consumption by a user interface of the communication device during playback of the media content;
decreasing the communication data rate during a first portion of the playback of the decoded media content having expected power consumption above a power threshold; and
increasing the communication data rate during a second portion of the playback of the decoded media content having expected power consumption below the power threshold.

5. The method of claim 4, wherein determining the expected power consumption by the user interface further comprises:
determining brightness and volume settings of one or more user interface devices of the communication devices; and
determining a respective amount of power required to display video and present audio of the decoded media content based on the determined brightness and volume settings.

6. The method of claim 2, wherein mitigating the temperature increase comprises:
determining an expected navigation path of the communication device relative to one or more communication nodes;
determining an expected dynamic transmission power level required for a communication session based on the expected navigation path; and
in response to determining that the expected dynamic transmission power level is above a power threshold:
reducing the communication data rate to reduce generated heat load;
buffering data that is generated in excess of an amount transmitted at the communication data rate; and
scheduling an increase in the communication data rate to transmit the buffered date to coincide with an expected dynamic transmission power level that is less than the power threshold.

7. The method of claim 6, wherein determining the expected navigation path comprises:
accessing an automatically-generated geographical route comprising a sequence of road segments and expected road speeds along the sequence of road segments;
determining, via the two or more antennas, a relative position of the one or more communication nodes along the geographical route; and
determining the expected dynamic transmission power level as a function of time based on the expected position of the communication device and the relative distance to a closest one of the one or more nodes.

8. The method of claim 6, wherein determining the expected navigation path comprises:
determining a current position and velocity of the communication device; and
extrapolating the current position based on the velocity.

9. The method of claim 1, wherein monitoring the respective temperatures comprises monitoring a respective temperature sensor integrated into each of the two or more antennas.

10. The method of claim 1, wherein monitoring the respective temperatures comprises monitoring a respective temperature sensor positioned proximate to each of the two or more antennas.

11. The method of claim 1, wherein monitoring the respective temperatures comprises monitoring an external surface temperature of an enclosure over each of the two or more antennas.

12. A communication device comprising:
two or more antennas that are spatially separated;
two or more temperature sensors positioned to sense a temperature of respective ones of the two or more antennas;
a modem communicatively coupled to the two or more antennas; and
a controller communicatively coupled to the modem and which executes an antenna selection utility that enables the communication device to:
monitor, by the controller, respective temperatures of two or more antennas of the communication device, including a first antenna having a first temperature;
transmit data by the modem to the first selected antenna;
compare each of the respective temperatures to a corresponding temperature threshold; and
in response to determining that the first temperature exceeds its corresponding temperature threshold:
determine whether at least one second antenna has an associated second temperature that is less than a corresponding second temperature threshold; and
in response to determining that at least one second antenna has a second temperature that is less than the corresponding second temperature threshold:
select a second antenna from among the at least one second antenna; and
switch data transmission from the modem to the selected second antenna.

13. The communication device of claim 12, wherein the controller enables the communication device to, in response to determining that no antenna from among the two or more antennas has a corresponding temperature that is less than the temperature threshold, mitigate a temperature increase of a currently selected antenna for data transmission by reducing a communication data rate.

14. The communication device of claim 12, wherein the controller enables the communication device to:
determine, by the controller, whether any of the two or more antennas is shadowed by proximity body; and
in response to determining that a currently selected one of the first and second antennas either is shadowed or has a temperature that is greater than the temperature threshold:
identify any candidate antennas of the two or more antennas that are not shadowed and has a temperature that is not greater than the temperature threshold;
in response to determining that at least one candidate antenna is identified:
selecting, by the controller, a third antenna from among the at least one candidate antenna; and
switching, by the controller, data transmission from the modem to the selected third antenna; and
in response to determining that no candidate antenna is identified, disabling transmission by the two or more antennas.

15. The communication device of claim 12, wherein, to reduce the communication data rate to mitigate a temperature increase of any currently selected antenna, the controller enables the communication device to:
decode media content to determine expected power consumption by a user interface of the communication device during playback of the media content;
decrease the communication data rate during a first portion of the playback of the decoded media content having expected power consumption above a power threshold; and
increase the communication data rate during a second portion of the playback of the decoded media content having expected power consumption below the power threshold.

16. The communication device of claim 14, wherein, to determine the expected power consumption by the user interface, the controller enables the communication device to:
determine brightness and volume settings of one or more user interface devices of the communication devices; and
determine a respective amount of power required to display video and present audio of the decoded media content based on the determined brightness and volume settings.

17. The communication device of claim 12, wherein, to mitigate the temperature increase, the controller enables the communication device to:
determine an expected navigation path of the communication device relative to one or more communication nodes;
determine an expected dynamic transmission power level required for a communication session based on the expected navigation path; and
in response to determining that the expected dynamic transmission power level is above a power threshold:
reduce the communication data rate to reduce generated heat load;
buffer data that is generated in excess of an amount transmitted at the communication data rate; and
schedule an increase in the communication data rate to transmit the buffered date to coincide with an expected dynamic transmission power level that is less than the power threshold.

18. The communication device of claim 17, wherein, to determine the expected navigation path, the controller enables the communication device to:
access an automatically-generated geographical route comprising a sequence of road segments and expected road speeds along the sequence of road segments;
determine, via the two or more antennas, a relative position of the one or more communication nodes along the geographical route;
determine the expected dynamic transmission power level as a function of time based on the expected position of the communication device and the relative distance to a closest one of the one or more nodes.

19. The communication device of claim 17, wherein, to determine the expected navigation path, the controller enables the communication device to:
determine a current position and velocity of the communication device; and
extrapolate the current position based on the velocity.

20. A computer program product comprising:
a computer readable storage device; and
program code on the computer readable storage device that when executed by a processor associated with a communication device, the program code enables the communication device to provide the functionality of:
monitoring, by a controller, respective temperatures of two or more antennas of the communication device, including a first antenna having a first temperature;
transmitting data by a modem to the first antenna;
comparing each of the respective temperatures to a corresponding temperature threshold; and
in response to determining that the first temperature exceeds its corresponding temperature threshold:
determining whether at least one second antenna of the two or more antennas has an associated second temperature that is less than a corresponding second temperature threshold; and
in response to determining that at least one second antenna has a second temperature that is less than the corresponding second temperature threshold:
selecting, by the controller, a second antenna from among the at least one second antenna; and
switching, by the controller, data transmission from the modem to the selected second antenna.
